(19) United States
(12) Patent Application Publication
(10) Pub. No.: US 2026/0238624 A1
(43) Pub. Date: Aug. 13, 2026

(54) CLASSIFYING AN OBJECT AS UNIQUE OR NON-UNIQUE FOR OBJECT-BASED AUTHENTICATION IN LIVENESS TESTING

(71) Applicant: Capital One Services, LLC, McLean, VA (US)

(72) Inventors: Joshua EDWARDS, Philadelphia, PA (US); Claire M. ROWLETT, Washington, DC (US); Tyler MAIMAN, Melville, NY (US); Mary SWEENEY, Walnut Creek, CA (US); Ramin MORADI, McLean, VA (US)

(21) Appl. No.: 19/050,570

(22) Filed: Feb. 11, 2025

(51) Int. Cl. H04L 9/40

(52) U.S. Cl. CPC H04L 63/08

(57) ABSTRACT

A method for performing object-based authentication for determining access to a user account includes detecting an enrollment event associated with the user account; obtaining, based on detecting the enrollment event, one or more enrollment images of an authentication object; classifying, using a classification machine learning model, the authentication object as unique or non-unique based on the one or more enrollment images; selecting an object authentication machine learning model for use during user authentication based on whether the authentication object is unique or non-unique, including selecting a first object authentication machine learning model based on the authentication object being unique, or selecting a second object authentication machine learning model based on the authentication object being non-unique; and configuring one or more processors to use the object authentication machine learning model for authenticating the user account during an authentication event.

### BACKGROUND

An authentication process may be performed for various purposes. For example, if a user attempts to gain access to an account associated with the user, the authentication process may be performed to verify an identity of the user to enable the user to access the account.

### SUMMARY

In some implementations, a system for enhanced user authentication using authentication object detection during a liveness verification for determining access for a user account includes one or more memories; and one or more processors, communicatively coupled to the one or more memories, configured to: detect an enrollment event associated with the user account, the enrollment event being initiated by an authorized user of the user account; obtain one or more enrollment images of an authentication object based on detecting the enrollment event; classify, using a classification machine learning model, the authentication object as unique or non-unique based on the one or more enrollment images; select an object authentication machine learning model for use during user authentication based on whether the authentication object is unique or non-unique, wherein a first object authentication machine learning model is selected as the object authentication machine learning model based on the authentication object being unique, or a second object authentication machine learning model is selected as the object authentication machine learning model based on the authentication object being non-unique; and configure the one or more processors to use the object authentication machine learning model for authenticating the user account during an authentication event.

In some implementations, a system for enhanced user authentication using authentication object detection during a liveness verification for determining access for a user account includes one or more memories; and one or more processors, communicatively coupled to the one or more memories, configured to: detect an enrollment event associated with the user account, the enrollment event being initiated by an authorized user of the user account; obtain one or more enrollment images of an authentication object based on detecting the enrollment event; classify, using a classification machine learning model, the authentication object as appropriate or inappropriate for being used for authentication based on the one or more enrollment images; and accept the authentication object for being used for authentication based on the authentication object being appropriate; or reject the authentication object for being used for authentication based on the authentication object being inappropriate.

In some implementations, a method for performing object-based authentication for determining access to a user account includes detecting an enrollment event associated with the user account, the enrollment event being initiated by an authorized user of the user account; obtaining, based on detecting the enrollment event, one or more enrollment images of an authentication object; classifying, using a classification machine learning model, the authentication object as unique or non-unique based on the one or more enrollment images; selecting an object authentication machine learning model for use during user authentication based on whether the authentication object is unique or non-unique, including selecting a first object authentication machine learning model as the object authentication machine learning model based on the authentication object being unique, or selecting a second object authentication machine learning model as the object authentication machine learning model based on the authentication object being non-unique; and configuring one or more processors to use the object authentication machine learning model for authenticating the user account during an authentication event.

### BRIEF DESCRIPTION OF THE DRAWINGS

FIGS. 1A-1G are diagrams of an example associated with enhanced user authentication using authentication object detection during a liveness verification for determining access for a user account, in accordance with some embodiments of the present disclosure.

FIG. 2 is a diagram illustrating an example of training and using a machine learning model in connection with enhanced user authentication using authentication object detection during a liveness verification for determining access for a user account, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with enhanced user authentication using authentication object detection during a liveness verification for determining access for a user account, in accordance with some embodiments of the present disclosure.

FIG. 5 is a flowchart of an example process associated with enhanced user authentication using authentication object detection during a liveness verification for determining access for a user account, in accordance with some embodiments of the present disclosure.

### DETAILED DESCRIPTION

The following detailed description of example implementations refers to the accompanying drawings. The same reference numbers in different drawings may identify the same or similar elements.

Some actions associated with user access may be based on authentication of information associated with an authorized user. An access attempt may be a log-in access attempt, an attempt to access sensitive information, and/or a transactional access attempt (e.g., for initiating a transaction), among other examples. An authentication system may require an access attempt to be authenticated prior to granting access or enabling the access attempt to proceed. For example, a website may use an authentication system to authenticate an identity of the user before granting the user access to the website. Multi-factor authentication (MFA) is an authentication technique in which a device of the user is granted access to a resource (e.g., a computing resource, an application, a transaction, and/or a page associated with an account) only after successfully presenting two or more factors to the authentication system. The two or more factors may include knowledge (e.g., something only the user knows), possession (e.g., something only the user has), and/or inherence (e.g., something only the user is), among other examples.

For example, the authentication system may authenticate an access attempt (e.g., to access a resource) using a user image of the user. The user image may depict a face of the user, which may be referred to as a “selfie.” Alternatively, the authentication system may authenticate an access attempt using an image of an object (e.g., a secret object, also referred to as an authentication object). An enrollment process may be used to store images of an authorized user’s face (e.g., for use during facial recognition for user authentication) or to store images of an authorized user’s authentication object (e.g., for use during object recognition for user authentication). Thus, an authorized user may have knowledge of which object was selected during the enrollment process to be used as the authentication object. Moreover, the authentication object may be unique to the authorized user.

Liveness testing is a security measure used to ensure that a person attempting to authenticate (e.g., through facial recognition, object recognition, or other identity recognition methods) is a real, live human and is the authorized user, and not an image, a video, a mask, or a deepfake (e.g., a filter). Liveness testing may play a crucial role in preventing spoofing attacks where an unauthorized person might try to trick the authentication system by presenting a photograph, pre-recorded video, a filter, or a three-dimensional (3D) model of an authorized person’s face or object. Liveness testing uses a premise of real-time interaction with an access requester in order to verify whether or not the access requester is the authorized user. During the liveness testing, the authentication system may require the access requester to use a live camera to provide live camera data (e.g., live camera images, live camera video, or a live camera stream) for analysis. Thus, the authentication system may challenge the access requester to provide evidence, by way of one or more inputs, that the access requester is the authorized user. For example, the authentication system may challenge the access requester to provide live camera data of their face and/or of their authentication object for verification against images stored during the enrollment process. Thus, using liveness testing, the authentication system may verify that the one or more inputs come from a live user interacting in real-time with the authentication system. The authentication system may analyze facial features, such as skin texture, skin tone, depth, and/or a 3D structure of the face, to ensure authenticity. Additionally, or alternatively, the authentication system may analyze object features, such as geometric shape, color, depth, size, weight, object type, object classification, and/or other object features, to ensure authenticity.

However, some objects may not be appropriate for use as an authentication object. For example, some objects may be too large, too heavy, and/or too common for practical use as an authentication object. For example, in some cases, it may be practical for a user to be able to carry the authentication object. Thus, it may be practical for the authentication object to be a hand-held object. Additionally, different objects may have different levels of uniqueness. Different levels of uniqueness may require different techniques to be used for assessing whether the object matches the authentication object. Allowing a user to use an inappropriate object or using a technique that is not suitable for analyzing the uniqueness level of an object may result in the authentication system consuming resources (e.g., computing resources, memory resources, networking resources, and/or other resources) associated with authenticating an access requester as an authorized user. For example, the authentication system may consume resources to perform the authentication over multiple iterations due to a user’s inability to access the object (e.g., due to inappropriateness), false authentication results (e.g., due to using unsuitable analyzing techniques), and/or circumvention by a malicious actor. As another example, the authentication system may consume resources to perform a forensic examination associated with the resource to determine whether the malicious actor caused any adverse effects to the resource. As another example, the authentication system may consume resources to provide notifications associated with the improper access to the resource. Thus, liveness testing must constantly evolve to provide resource-efficient authentication techniques and to stay ahead of increasingly sophisticated methods used to bypass liveness detection.

Some implementations described herein provide a system for enhanced user authentication using authentication object detection during a liveness verification for determining access for a user account. In some implementations, an authentication system may use artificial intelligence (AI), such as a machine learning model, to classify an object during an enrollment process and to determine whether the object is appropriate or inappropriate for use as an authentication object. In some implementations, the authentication system may use AI, such as a machine learning model, to classify the authentication object during the enrollment process as unique or non-unique, and to select an object authentication machine learning model, from among multiple object authentication machine learning models, for use during user authentication based on whether the authentication object is unique or non-unique. The enrollment process may be associated with an account registration process, an account setup process, and/or an account configuration process. In some cases, the enrollment process may be associated with enabling a feature within a user account.

In some implementations, the authentication system may use the selected object authentication machine learning model during an authentication process, during which the selected object authentication machine learning model authenticates an access requester as an authorized user based on a live (real-time) interaction with an object, presented by the access requester as the authentication object. The authentication process may be part of an MFA protocol. In some implementations, an authentication system may use AI, such as a machine learning model, to detect possible fraudulent activity (e.g., deepfakes (filters), physical masks, or duress (fraud by force)) during a live image verification. For example, the authentication system may detect an authentication event associated with an access attempt for the user account, and initiate a liveness testing. In some cases, the liveness testing may be initiated as part of an initial access attempt (e.g., to access an account page or webpage). In some cases, the liveness testing may be initiated as part of a stepped-up authentication protocol, during which the authentication system increases a security level of authentication measures that are required to be passed prior to granting access. For example, the authentication system may trigger stepped-up authentication as part of a further access attempt to access sensitive information or to conduct a transaction.

Based on detecting possible fraudulent activity, the authentication system may step up the liveness to more advanced liveness detection tasks that may provide the authentication system with additional data points for detecting fraudulent activity and/or for authenticating the access requester as the authorized user. In other words, the authentication system may use AI to detect possible fraudulent activity, and may further use AI to perform more advanced liveness detection tasks based on possible fraudulent activity being detected. During stepped up verification, the authentication system may require the access requester to provide additional live digital evidence in the form of images, video, and/or audio for evaluation prior to granting access to an account or features within the account.

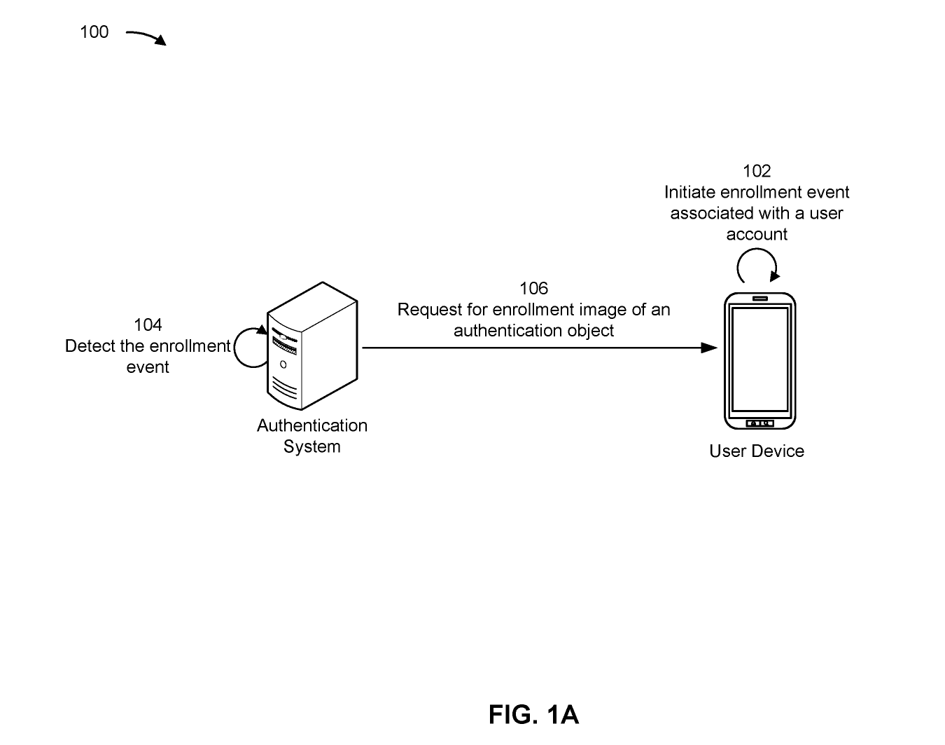

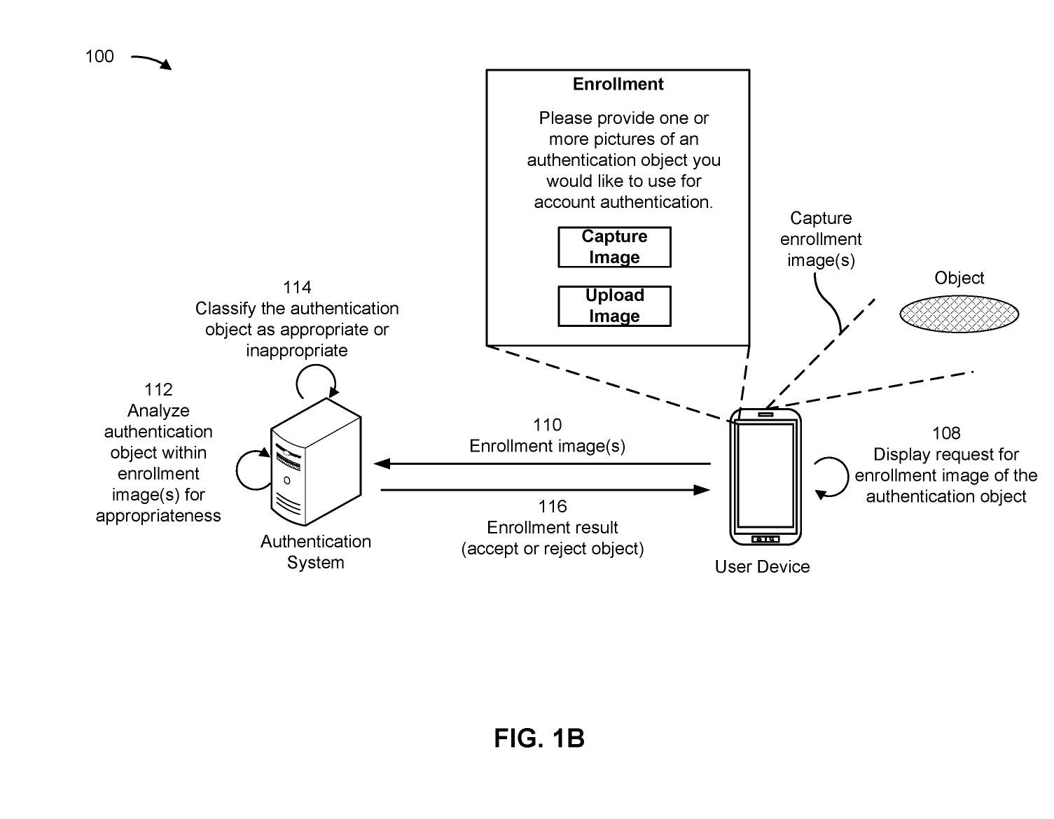

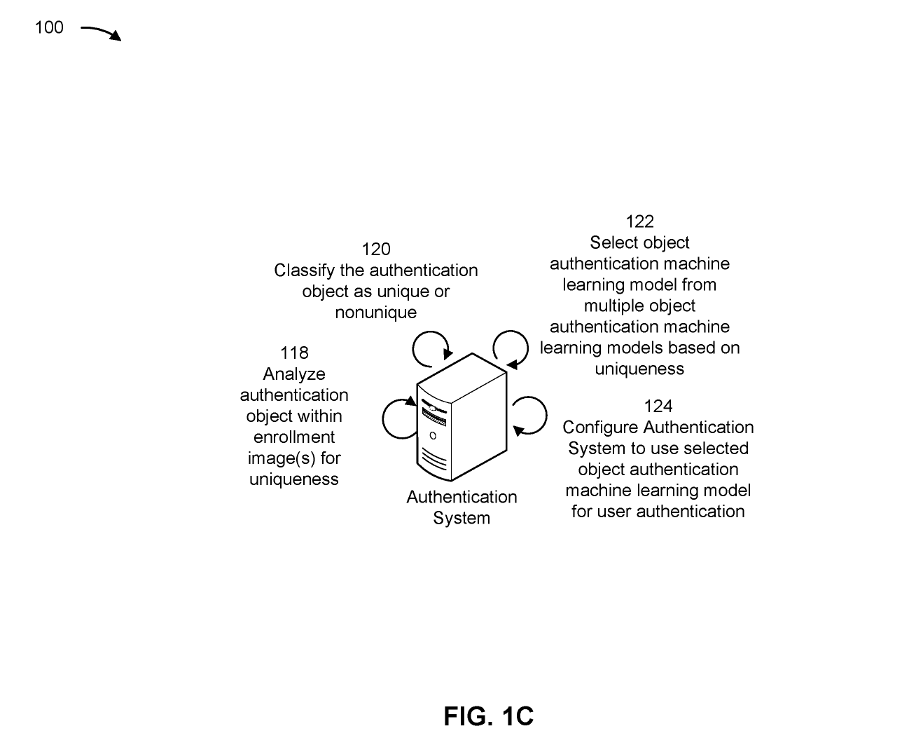

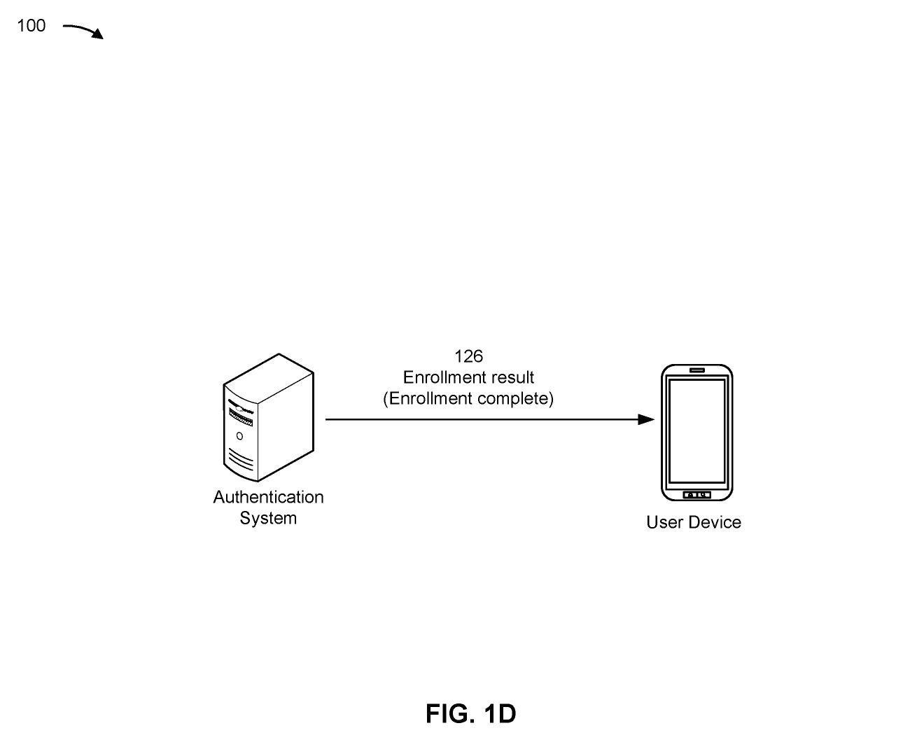

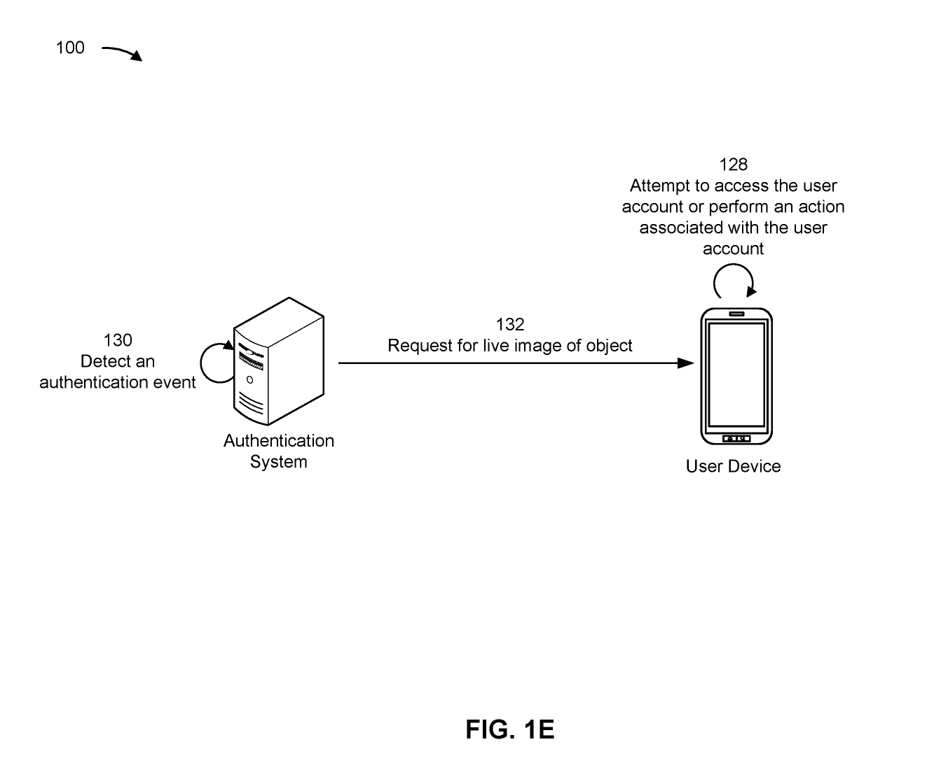

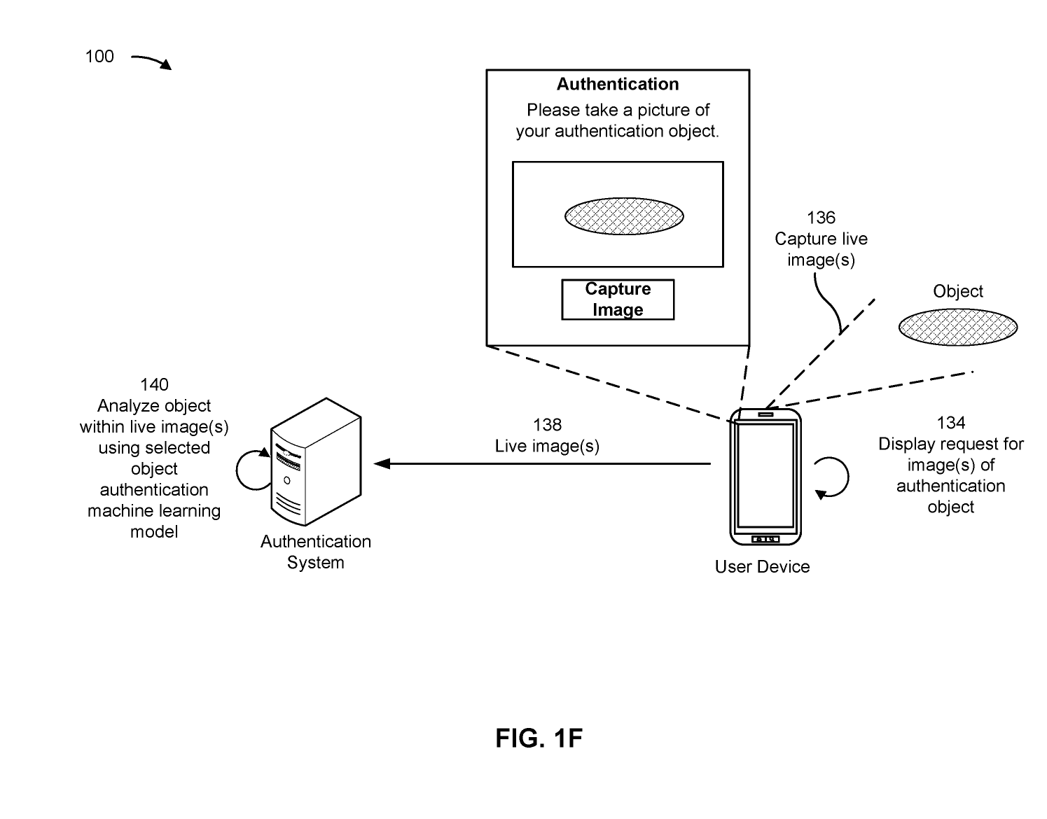

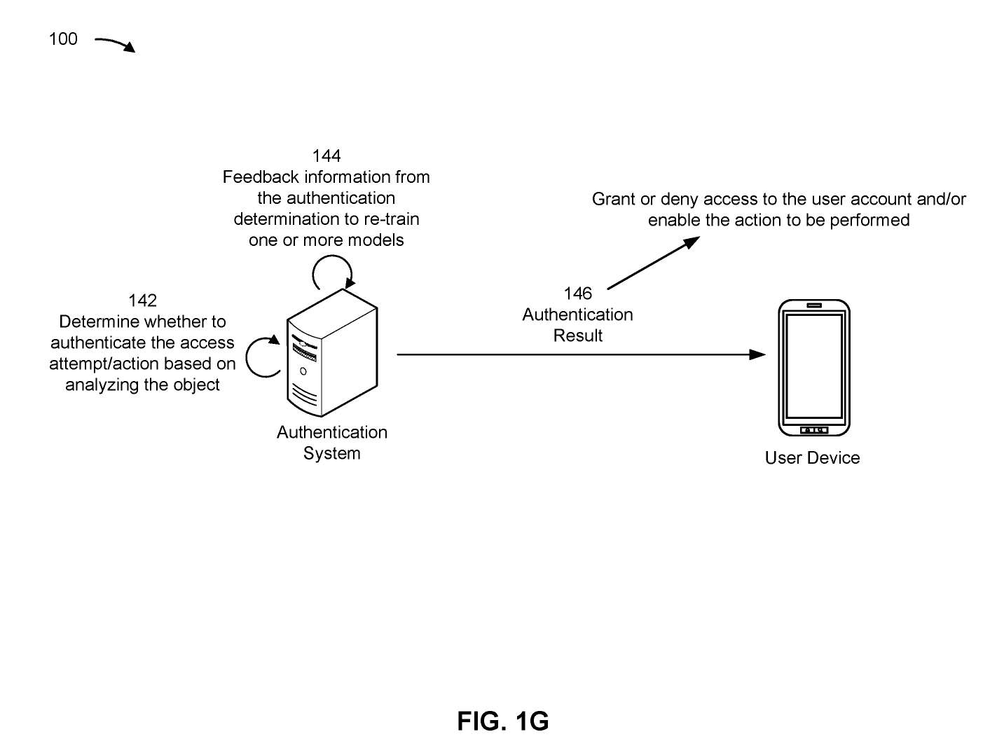

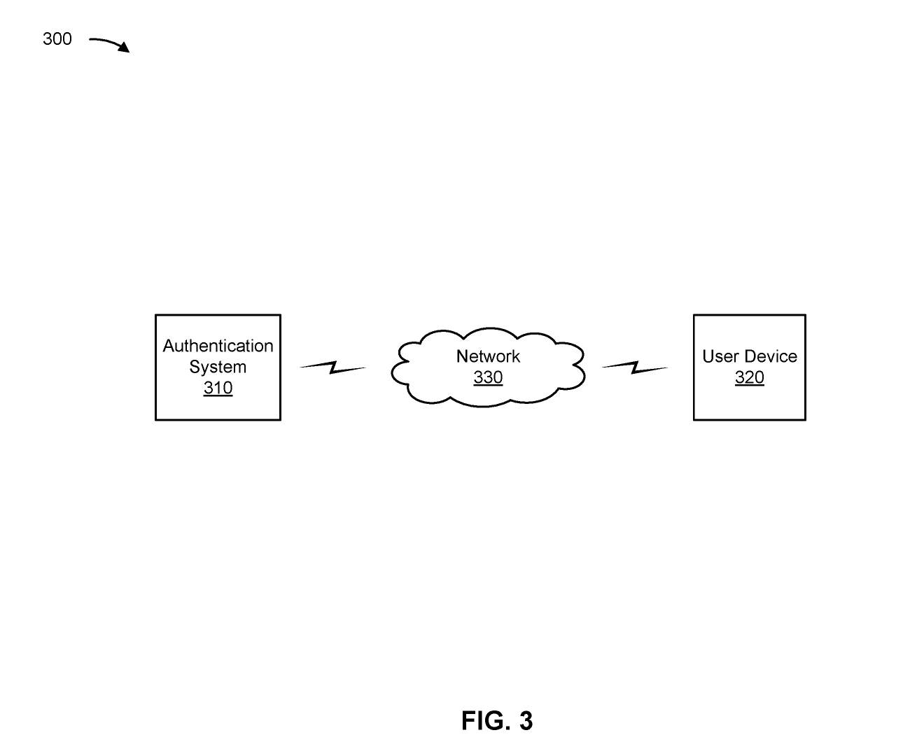

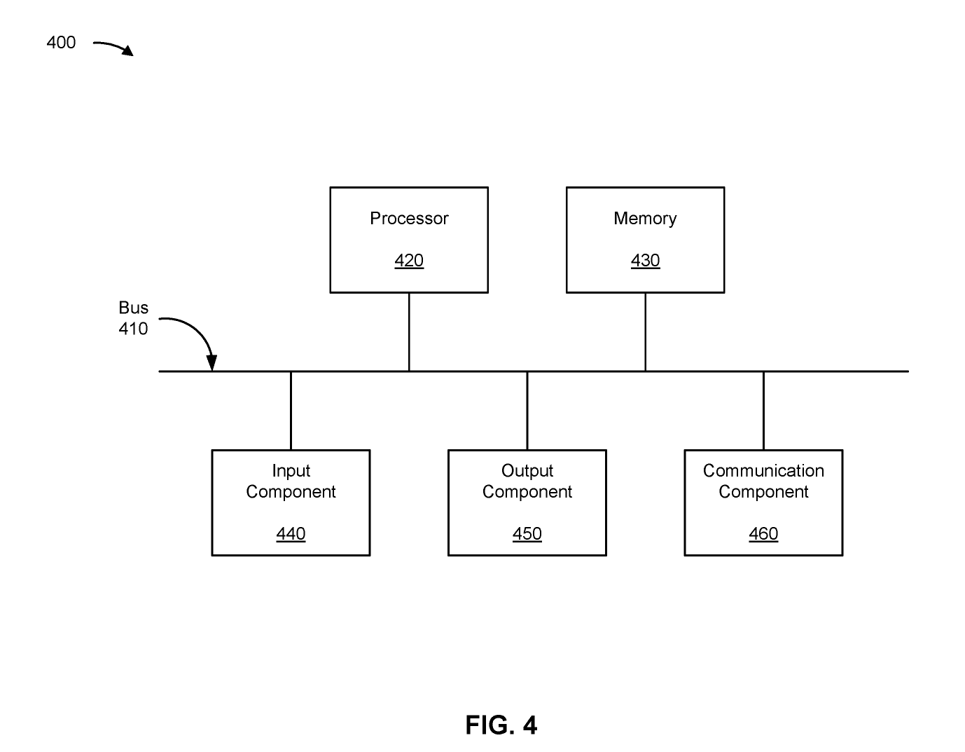

FIGS. 1A-1G are diagrams of an example 100 associated with enhanced user authentication using authentication object detection during a liveness verification for determining access for a user account. As shown in FIGS. 1A-1G, example 100 includes an authentication system and a user device. The authentication system and the user device are described in more detail in connection with FIGS. 3 and 4.

In some implementations, the authentication system may be associated with an entity, such as an organization, a merchant, and/or a financial institution, that generates, provides, manages, and/or maintains an account (or other resource) associated with a user and/or that performs actions associated with the user. For example, the authentication system may be associated with an entity that generates, provides, manages, and/or maintains a credit card account, a loan account, a capital loan account, a checking account, a savings account, a reward account, a payment account, and/or a user account associated with the user, among other examples. As an example, the authentication system may enroll a user with a user account or a feature associated with the user account. Additionally, the authentication system may authenticate an access attempt, performed by the user, to the account, and/or the authentication system may perform an action (e.g., authorize and/or enable an action of the user to be performed) based on determining whether an access requester is an authorized user of the user account.

As shown in FIG. 1A, and by reference number 102, the user device may obtain an indication of an enrollment event associated with a user account. For example, a user (e.g., an access requester) may initiate a registration for the user account or for an activation of a feature associated with the user account. The user may initiate the registration for the user account by providing one or more enrollment credentials, such as a username and a password. For example, the entity may be a credit card issuer that generates, provides, manages, and/or maintains a credit card account associated with the authorized user, and the user may enroll in a credit card account by performing an enrollment process associated with the credit card account. As an example, the user device may obtain credentials, such as login credentials, via a graphical user interface (GUI) of a website associated with the credit card issuer, to perform the enrollment associated with the credit card account.

As another example, the entity may be a merchant that operates an application that is executable on the user device of the user, such as a food delivery service application. For example, the merchant may generate, provide, manage, and/or maintain an account associated with an authorized user.

As shown by reference number 104, the authentication system may detect the enrollment event and perform the enrollment process, including obtaining and processing user information received from the user device in order to establish the user account for the user.

As shown by reference number 106, the authentication system may transmit, and the user device may receive, a request for one or more enrollment images of an authentication object to be used for authenticating the user as an authorized user in response to authentication events. The request for one or more enrollment images may include a request to provide enrollment images of the authentication object at different angles and/or viewpoints. The authentication object may be an object selected by the user that can be used to identify or otherwise authenticate the user as the authorized user during a liveness test (e.g., a liveness verification).

As shown in FIG. 1B, and by reference number 108, the authentication system may cause the user device to display a request for the one or more enrollment images of the authentication object. For example, the user device may display a GUI based on receiving the request for the one or more enrollment images of the authentication object. The user device may enable the user to capture one or more images of the authentication object using a camera of the user device and/or upload one or more images of the authentication object from a storage device. In some implementations, the user may provide an input to the user device for providing the one or more enrollment images. For example, the user may align the camera of the user device with the authentication object and may press a “Capture Image” button on the GUI to capture the one or more images of the authentication object.

In some implementations, the user device may generate metadata associated with the one or more enrollment images based on capturing live images. As an example, the metadata associated with the one or more enrollment images may include geographic location information that corresponds to a location associated with the user device at a time at which the live images are captured and/or timestamp information that corresponds to a time at which the live images are captured, among other examples. The metadata may be used as additional verification information.

Thus, the user device may capture the one or more enrollment images of the authentication object. The one or more enrollment images of the authentication object may be stored in a buffer memory or other memory storage accessible for transmission. The user device may prepare a communication for sending the one or more enrollment images of the authentication object to the authentication system.

As shown by reference number 110, the authentication system may obtain, and the user device may transmit, the one or more enrollment images of the authentication object.

As shown by reference number 112, the authentication system may analyze, using a first classification machine learning model, the authentication object within the enrollment images for appropriateness. For example, the authentication system may detect and/or extract the authentication object from the enrollment images for analysis. The authentication system may access one or more image libraries of different objects, with corresponding classifications, and determine which object the authentication object most closely resembles or matches. Additionally, the authentication system may use the one or more image libraries and corresponding classifications to classify a weight and size of the authentication object.

As shown by reference number 114, the authentication system may classify, using the first classification machine learning model, the authentication object as appropriate or inappropriate for being used for authentication based on the one or more enrollment images. For example, the authentication system may determine that the authentication object is appropriate or inappropriate based on type, weight, and/or size of the authentication object. In some cases, the authentication system may determine that the authentication object is too heavy and/or too large to be practically used as an authentication object, and may, therefore, determine that the authentication object is inappropriate. Alternatively, the authentication system may determine that the authentication object satisfies all requirements for being used as an authentication object and may, therefore, determine that the authentication object is appropriate.

As shown by reference number 116, the authentication system may notify the user that the authentication object is appropriate or inappropriate by transmitting a message to the user device. If the authentication system determines that the authentication object is inappropriate, the authentication system may request the user to select a different object, and the enrollment process, including reference numbers 106-114, may be repeated until enrollment images of an appropriate authentication object are provided. Thus, the authentication system may accept the authentication object for being used for authentication based on the authentication object being appropriate, or may reject the authentication object for being used for authentication based on the authentication object being inappropriate. If the authentication system determines that the authentication object is appropriate, the authentication system may store the one or more enrollment images of the (appropriate) authentication object as reference images to be used during authentication.

As shown in FIG. 1C, and by reference number 118, the authentication system may analyze, using a second classification machine learning model, the authentication object within the enrollment images for uniqueness. For example, the authentication system may detect and/or extract the authentication object from the enrollment images for analysis. The first classification machine learning model and the second classification machine learning model may be a same classification machine learning model or different classification machine learning models. In some implementations, the second classification machine learning model may be a pre-trained binary classifier model configured to classify the authentication object as unique or non-unique.

In some examples, the authentication system may analyze, using the second classification machine learning model, the one or more enrollment images to determine a uniqueness score of the authentication object based on one or more uniqueness factors. The authentication system may classify the authentication object as unique based on the uniqueness score satisfying a uniqueness threshold, or may classify the authentication object as non-unique based on the uniqueness score not satisfying the uniqueness threshold.

In some examples, the authentication system may generate, using the second classification machine learning model, an embedding based on the one or more enrollment images (e.g., based on the authentication object), compare, using the second classification machine learning model, the embedding with embeddings of common objects (e.g., non-unique objects) based on a distance metric to generate one or more comparison results, and classify, using the second classification machine learning model, the authentication object as unique or non-unique based on the comparison results.

An embedding is a specific representation of data in the form of a vector, often in a continuous vector space. In other words, an embedding is an n-dimensional vector (embedding vector) in a vector space (n-dimensional vector space) generated by vectorizing the input to capture meaningful relationships in the data. An embedding may be specifically optimized for tasks like classification, similarity, or clustering. An embedding may be learned during a training process to represent data points (e.g., words or images) in a way that preserves semantic or structural properties. Vectors (or embeddings) may be compared using distance metrics (e.g., Euclidean distance or cosine similarity) to determine how similar two data points are. For example, in a Siamese neural network used in one or more implementations described herein, embeddings of two inputs are compared in order to check similarity.

As shown by reference number 120, the authentication system may classify, using the second classification machine learning model, the authentication object as unique or non-unique based on analyzing the authentication object within the one or more enrollment images.

As shown by reference number 122, the authentication system may select an object authentication machine learning model for use during user authentication based on whether the authentication object is unique or non-unique (e.g., based on uniqueness). The object authentication machine learning model may be selected from two or more different object authentication machine learning models, where each different object authentication machine learning model corresponds to a different amount or range of uniqueness. For example, a first object authentication machine learning model may be selected as the object authentication machine learning model based on the authentication object being unique. Alternatively, a second object authentication machine learning model may be selected as the object authentication machine learning model based on the authentication object being non-unique.

In some examples, the first object authentication machine learning model may be a Siamese neural network, and the second object authentication machine learning model may be an image recognition classification model (e.g., a traditional neural network trained to classify inputs into predefined categories).

As shown by reference number 124, the authentication system may configure one or more processors of the authentication system to use the object authentication machine learning model (e.g., the selected object authentication machine learning model) for authenticating the user account during an authentication event. In other words, the authentication system may use the selected object authentication machine learning model for authenticating an object as the authentication object during an authentication process in order to authenticate or otherwise verify the access requester as the authorized user.

Based on the authentication object being unique, the authentication system may generate, using the first object authentication machine learning model, one or more reference embeddings of the authentication object based on the one or more enrollment images; and store, in the one or more memories, the one or more reference embeddings in association with the user account. The one or more reference embeddings may be stored for use during an authentication event (e.g., for use during an authentication process).

Alternatively, based on the authentication object being non-unique, the authentication system may determine, using the second object authentication machine learning model, a reference object classification of the authentication object based on the one or more enrollment images; and store, in the one or more memories, the reference object classification in association with the user account, the reference object classification being stored for use during the authentication event (e.g., for use during an authentication process). In some implementations, based on the authentication object being non-unique, the authentication system may generate, using the second object authentication machine learning model, one or more reference classification embeddings of the authentication object based on the one or more enrollment images; and determine, using the second object authentication machine learning model, the reference object classification based on the one or more reference classification embeddings.

As shown in FIG. 1D, and by reference number 126, the authentication system may transmit, and the user device may receive, a message indicating an enrollment result. For example, the message may indicate that the authentication object has been accepted, registered, and otherwise associated with the user account, thus completing the enrollment.

As shown in FIG. 1E, and by reference number 128, the user device may obtain an indication of an access attempt associated with a user account. For example, a user (e.g., an access requester) may attempt to access an account and/or may perform an action associated with the account. For example, the entity may be a credit card issuer that generates, provides, manages, and/or maintains a credit card account associated with the authorized user, and the access requester may attempt to access the credit card account by performing a login associated with the credit card account. As an example, the user device may obtain credentials, such as login credentials, via a GUI of a website associated with the credit card issuer, to perform the login associated with the credit card account.

As another example, the entity may be a merchant that operates an application that is executable on the user device of the access requester, such as a food delivery service application. For example, the merchant may generate, provide, manage, and/or maintain an account associated with the authorized user. The user device may perform the action associated with the account by obtaining a payment associated with the application account, such as by obtaining credit card information entered into a GUI of the application associated with the application account. In other words, the attempt to access the account may include a login attempt, a payment attempt, and/or an attempt to access and/or modify information associated with the account (e.g., payment information), among other examples.

In some examples, an access attempt may be associated with performing an action associated with the user account. For example, the access requester may attempt to initiate a transaction (e.g., a withdrawal) or access sensitive information.

As shown by reference number 130, the authentication system may detect an authentication event. In some implementations, the authentication event may be an event that the authentication system detects that triggers the authentication system to perform an authentication protocol, as described in more detail elsewhere herein. For example, the authentication event may be associated with a multi-factor authentication protocol.

In some implementations, the authentication event may be associated with the attempt to access the account performed by the access requester. As an example, if the authentication system is associated with the credit card issuer and the access requester attempts to access the credit card account by performing the login associated with the credit card account, then the authentication system may detect the login associated with the credit card account, performed by the access requester, as the authentication event.

In some implementations, the authentication event may be associated with the action associated with the account performed by the access requester. As an example, if the authentication system is associated with the merchant that operates the application and the access requester performs the payment associated with the application account, then the authentication system may detect the payment, performed by the access requester, as the authentication event. In some implementations, the authentication event may be associated with multi-factor authentication (e.g., a multi-factor authentication event). For example, the access attempt to the account performed by the access requester may indicate valid login credentials, but the access requester may incorrectly answer a verification question. The authentication system may detect the incorrect answer provided by the access requester as the authentication event. In this example, the authentication system may request an additional authentication factor from the access requester as part of a stepped-up authentication protocol.

As shown by reference number 132, the authentication system may transmit, and the user device may receive, a request for a live image of the authentication object associated with the user account. For example, the authentication system may transmit, and the user device may receive, the request for the live image based on detecting the authentication event associated with the access attempt to the account and/or an action performed in connection with the account. The authentication system may use the live image to authenticate the access requester as the authorized user, as one authentication factor. In some cases, the authentication system may request the access requester to provide multiple live images of the authentication object from different angles.

As shown in FIG. 1F, and by reference number 134, the authentication system may cause the user device to display a request for the live image(s) of the authentication object. For example, the user device may display a GUI based on receiving the request for the live image(s) from the authentication system.

The user device may capture the live image(s). The user device may enable a camera of the user device based on receiving the request for the live image(s). In some implementations, the user may provide an input to the user device for providing the live image(s). For example, the access requester may place an object in a field of view of the camera of the user device and may press a “Capture Image” button on the GUI to capture the live image(s).

In some implementations, the user device may generate metadata associated with the live image(s) based on capturing the live image(s). As an example, the metadata associated with the live image(s) may include geographic location information that corresponds to a location associated with the user device at a time at which the live image(s) are captured and/or timestamp information that corresponds to a time at which the live image(s) are captured, among other examples.

In some implementations, the geographic location information that corresponds to the location associated with the user device may be based on network connection information associated with the user device, such as wireless Internet connection information and/or mobile data connection information associated with the user device, and/or coordinate information, such as latitude and longitude coordinates associated with a geographic location obtained by a global positioning system (GPS) of the user device. As an example, the authentication system may determine one or more locations associated with the user device based on the geographic location information. The authentication system may be configured to verify the location of the access requester based on the location information. Additionally, or alternatively, the authentication system may be configured to verify that images received from the user device are live images based on the timestamp information.

As shown by reference number 136, the user device may capture the live image(s) of an object. If the access requester is a malicious actor, the object may not be the authentication object. The live image(s) may be stored in a buffer memory or other memory storage accessible for transmission. The user device may prepare a communication for sending the live image(s) to the authentication system.

As shown by reference number 138, the authentication system may obtain, and the user device may transmit, the live image(s) of the object.

As shown by reference number 140, the authentication system may analyze the object depicted in the live image(s), using the object authentication machine learning model previously selected and configured during the enrollment process. Thus, the object authentication machine learning mode may be the selected object authentication machine learning mode that has been associated with the user account for object authentication. The authentication system may analyze, using the object authentication machine learning model, the object within the live image(s) to verify whether or not the object corresponds to the authentication object.

Based on the authentication object being unique, the authentication system may generate, using the first object authentication machine learning model, an embedding of the object based on the live image; compare, using the first object authentication machine learning model, the embedding with the one or more reference embeddings to generate one or more comparison results; and determine, using the first object authentication machine learning model, whether or not the object corresponds to the authentication object based on the one or more comparison results. In some implementations, the comparison results may be distance measurements acquired based on a distance metric (e.g., based on Euclidean distance or cosine similarity).

Based on the authentication object being non-unique, the authentication system may determine, using the second object authentication machine learning model, an object classification of the object based on the live image; compare, using the second object authentication machine learning model, the object classification with the reference object classification to generate a comparison result; and determine, using the second object authentication machine learning model, whether or not the object corresponds to the authentication object based on the comparison result. In some implementations, the authentication system may generate, using the second object authentication machine learning model, a classification embedding of the object based on the live image; and determine, using the second object authentication machine learning model, the object classification based on the classification embedding.

As shown in FIG. 1G, and by reference number 142, the authentication system may determine whether to authenticate the access attempt and/or action based on analyzing the object, as described in more detail elsewhere herein. The authentication system may authenticate the access attempt and/or action based on the object being verified as the authentication object associated with the user account. For example, the authentication system may authenticate the access attempt and/or action based on the object matching the authentication object registered to the user account during the enrollment process. In some implementations, the authentication system may determine, based on metadata received with the images(s), that the image(s) are not live image(s), and invalidate the access attempt based on the image(s) not being live image(s). For example, the authentication system may analyze the generated metadata and device telemetry to ensure that the image(s) received from the user device are live image(s).

As shown by reference number 144, the authentication system may obtain feedback information from the authentication determination to re-train one or more models. In some implementations, the authentication system may provide feedback, to a prediction model, that indicates that the live images(s) are associated with the authorized user. In some implementations, providing the feedback, such as prompts used during a live identity verification challenge, and corresponding authentication decisions, to the machine learning model may improve the machine learning model. For example, providing the feedback to the machine learning model may improve the accuracy of the machine learning model and/or may improve feature selection associated with the machine learning model.

As shown by reference number 146, the authentication system may grant or deny access to the account and/or enable the action to be performed. The authentication system may transmit, and the user device may receive, a message indicating an authentication result. For example, the message may indicate that the object has been authenticated as the authentication object and access has been granted. Alternatively, the message may indicate that the object does not match the authentication object or is otherwise invalid and access has been denied.

In this way, some implementations described herein provide enhanced user authentication using authentication object detection during a liveness verification for determining access for a user account. Because the authentication system uses enhanced authentication techniques using a live verification challenge with live digital evidence (e.g., live images), the authentication system may consume fewer resources as compared to other authentication techniques (e.g., by avoiding a need to perform actions associated with incorrect authentication determinations, such as forensic examination of data, generating notifications, and/or transmitting the notifications).

In some implementations, the authentication system may transmit fraud alert information, corresponding to detected fraudulent activity, to one or more investigator networks.

As indicated above, FIGS. 1A-1G are provided as an example. Other examples may differ from what is described with regard to FIGS. 1A-1G.

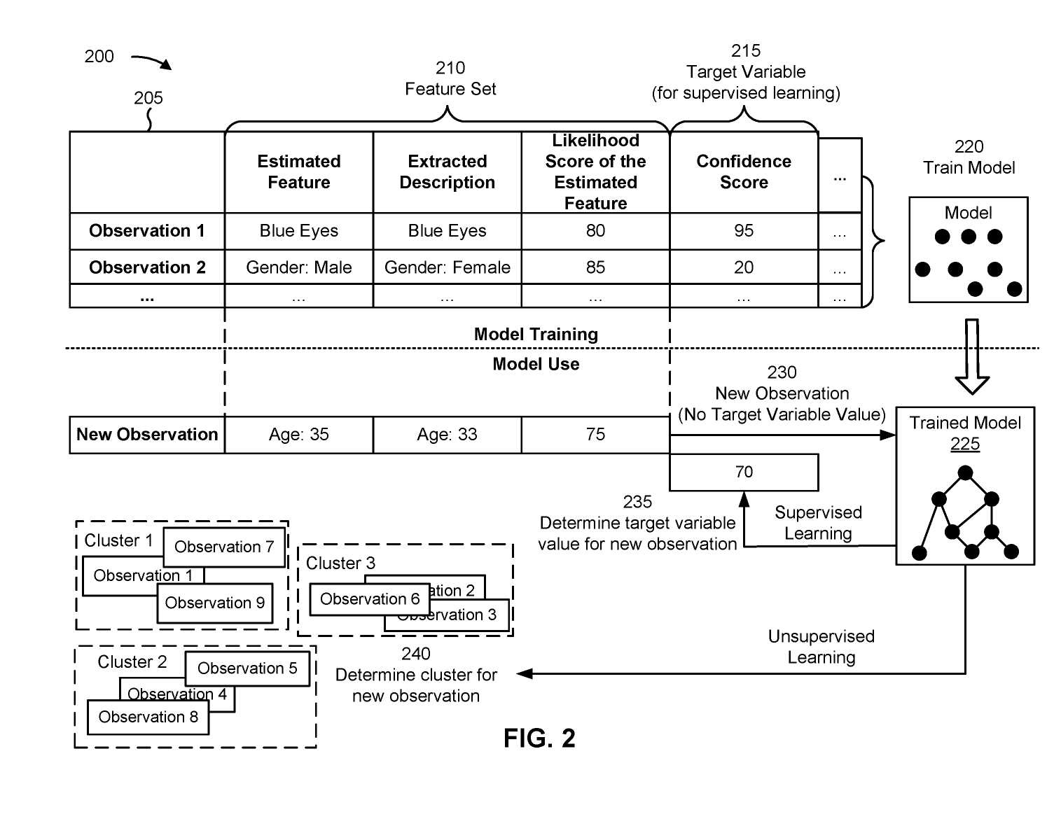

FIG. 2 is a diagram illustrating an example 200 of training and using a machine learning model in connection with enhanced user authentication using authentication object detection during a liveness verification for determining access for a user account. The machine learning model training and usage described herein may be performed using a machine learning system. The machine learning system may include or may be included in a computing device, a server, a cloud computing environment, or the like, such as the authentication device described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the authentication device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the authentication device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of an estimated feature, a second feature of extracted description, a third feature of likelihood score of the estimated feature, and so on. As shown, for a first observation, the first feature may have a value of blue eyes, the second feature may have a value of blue eyes, the third feature may have a value of 80, and so on. These features and feature values are provided as examples, and may differ in other examples. For example, the feature set may include one or more of the following features: appearance parameters, such as an age, an eye color, a gender, a skin color, a facial characteristic, a weight, and/or a height, among other examples. For performing object authentication, the feature set may be associated with one or more object parameters, such as object type, shape, geometry, lines, angles, reflectivity, surface area, surface texture, surface pattern, size, weight, and/or color, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is confidence score, which has a value of 95 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical data associated with one or more appearance parameters, such as one or more appearance parameters associated with an image that depicts a face of a person.

As shown by reference number 230, the machine learning system may apply the trained machine learning model 225 to a new observation, such as by receiving a new observation and inputting the new observation to the trained machine learning model 225. As shown, the new observation may include a first feature of estimated feature, a second feature of extracted description, a third feature of likelihood score of the estimated feature, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 70 for the target variable of confidence score for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation that the authentication device authenticates the access attempt and/or a recommendation that the authentication device performs the action. The first automated action may include, for example, causing the authentication device to authenticate the access attempt and/or causing the authentication device to perform the action.

As another example, if the machine learning system were to predict a value of 20 for the target variable of confidence score, then the machine learning system may provide a second (e.g., different) recommendation (e.g., a recommendation that the authentication device does not authenticate the access attempt and/or a recommendation that the authentication device does not perform the action) and/or may perform or cause performance of a second (e.g., different) automated action (e.g., causing the authentication device to generate an alert).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., definitely authenticate), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., maybe authenticate), then the machine learning system may provide a second (e.g., different) recommendation (e.g., a recommendation that the authentication device requests additional authentication information from the user) and/or may perform or cause performance of a second (e.g., different) automated action, such as causing the authentication device to request additional authentication information from the user.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. In some implementations, the machine learning model may be based on a liveness testing model. For example, the liveness testing model may determine one or more tasks suitable for a live identity verification challenge, generate prompts for the one or more tasks, analyze digital evidence associated with a performance of the one or more tasks to verify whether the access requester is the authorized user of the user account, and/or generate an output that indicates whether an access attempt is authentic, as described in more detail elsewhere herein. In this example, the machine learning model may determine the confidence score based on the digital evidence.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). Providing the feedback to the machine learning model may improve the accuracy of the machine learning model and/or may improve feature selection associated with the machine learning model.

In this way, the machine learning system may apply a rigorous and automated process to object enrollment and authentication. The machine learning system may enable recognition and/or identification of tens, hundreds, thousands, or millions of features and/or feature values for tens, hundreds, thousands, or millions of observations, thereby increasing accuracy and consistency and reducing delay associated with object enrollment and authentication, relative to requiring computing resources to be allocated for tens, hundreds, or thousands of operators to manually authenticate access attempts and/or perform actions using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an authentication system 310, a user device 320, and/or a network 330. Devices of environment 300 may interconnect via wired connections, wireless connections, or a combination of wired and wireless connections.

The authentication system 310 may include one or more devices capable of receiving, generating, storing, processing, providing, and/or routing information associated with enhanced user authentication using authentication object detection during a liveness verification for determining access for a user account, as described elsewhere herein. The authentication system 310 may include a communication device and/or a computing device. For example, the authentication system 310 may include a server, such as an application server, a client server, a web server, a database server, a host server, a proxy server, a virtual server (e.g., executing on computing hardware), or a server in a cloud computing system. In some implementations, the authentication system 310 may include computing hardware used in a cloud computing environment.

The user device 320 may include one or more devices capable of receiving, generating, storing, processing, and/or providing information associated with object enrollment and authentication, as described elsewhere herein. The user device 320 may include a communication device and/or a computing device. For example, the user device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 330 may include one or more wired and/or wireless networks. For example, the network 330 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 330 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with enhanced user authentication using authentication object detection during a liveness verification for determining access for a user account. The device 400 may correspond to the authentication system 310 (e.g., an authentication device of the authentication system 310) and/or the user device 320. In some implementations, the authentication system 310 and/or the user device 320 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

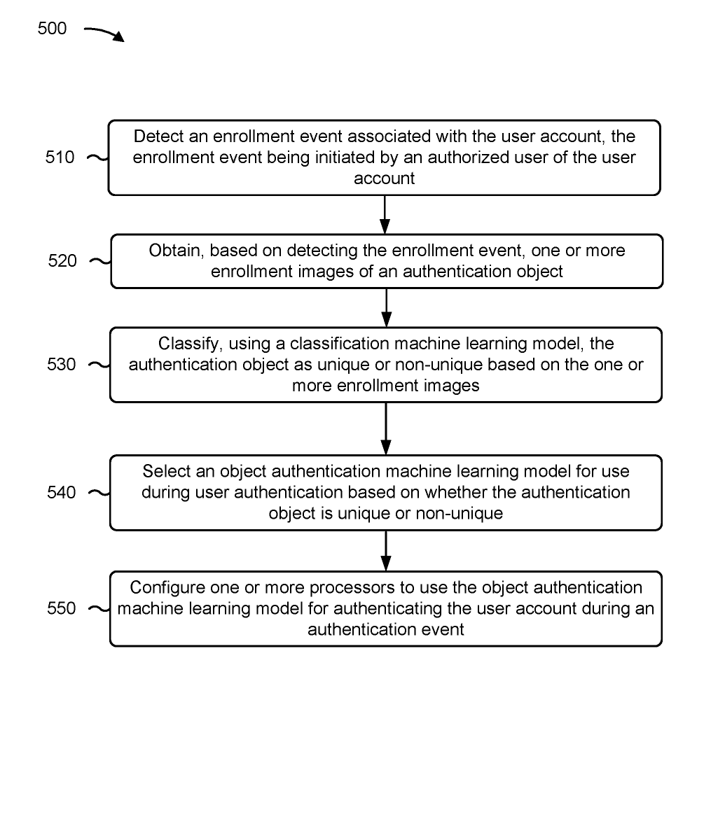

FIG. 5 is a flowchart of an example process 500 associated with enhanced user authentication using authentication object detection during a liveness verification for determining access for a user account. The process 500 may be associated with classifying an object as non-unique for object-based authentication in liveness testing. In some implementations, one or more process blocks of FIG. 5 may be performed by the authentication system 310 or the user device 320. In some implementations, one or more process blocks of FIG. 5 may be performed by another device or a group of devices separate from or including the authentication system 310. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include detecting an enrollment event associated with the user account, the enrollment event being initiated by an authorized user of the user account (block 510). For example, the authentication system 310 (e.g., using processor 420 and/or memory 430) may detect an enrollment event associated with the user account, the enrollment event being initiated by an authorized user of the user account, as described above in connection with reference number 104 of FIG. 1A.

As further shown in FIG. 5, process 500 may include obtaining, based on detecting the enrollment event, one or more enrollment images of an authentication object (block 520). For example, the authentication system 310 (e.g., using processor 420 and/or memory 430) may obtain, based on detecting the enrollment event, one or more enrollment images of an authentication object, as described above in connection with reference number 110 of FIG. 1B.

As further shown in FIG. 5, process 500 may include classifying, using a classification machine learning model, the authentication object as unique or non-unique based on the one or more enrollment images (block 530). For example, the authentication system 310 (e.g., using processor 420 and/or memory 430) may classify, using a classification machine learning model, the authentication object as unique or non-unique based on the one or more enrollment images, as described above in connection with reference numbers 118 and 120 of FIG. 1C.

As further shown in FIG. 5, process 500 may include selecting an object authentication machine learning model for use during user authentication based on whether the authentication object is unique or non-unique, including selecting a first object authentication machine learning model as the object authentication machine learning model based on the authentication object being unique, or selecting a second object authentication machine learning model as the object authentication machine learning model based on the authentication object being non-unique (block 540). For example, the authentication system 310 (e.g., using processor 420 and/or memory 430) may select an object authentication machine learning model for use during user authentication based on whether the authentication object is unique or non-unique, as described above in connection with reference number 122 of FIG. 1C.

As further shown in FIG. 5, process 500 may include configuring one or more processors to use the object authentication machine learning model for authenticating the user account during an authentication event (block 550). For example, the authentication system 310 (e.g., using processor 420 and/or memory 430) may configure one or more processors to use the object authentication machine learning model for authenticating the user account during an authentication event, as described above in connection with reference number 124 of FIG. 1C.

In some implementations, process 500 may include, based on the authentication object being unique: generating, using the first object authentication machine learning model, one or more reference embeddings based on the one or more enrollment images; and storing, in one or more memories, the one or more reference embeddings in association with the user account, the one or more reference embeddings being stored for use during the authentication event.

In some implementations, process 500 may include, based on the authentication object being non-unique: determining, using the second object authentication machine learning model, a reference object classification based on the one or more enrollment images; and storing, in the one or more memories, the reference object classification in association with the user account, the reference object classification being stored for use during the authentication event.

In some implementations, process 500 may include detecting the authentication event, the authentication event being associated with an access attempt for the user account, and the access attempt being initiated by an access requester; obtaining a live image of an object associated with the authentication event based on detecting the authentication event; analyzing, using the object authentication machine learning model, the object within the live image to verify whether or not the object corresponds to the authentication object; and performing one of: authenticating the access attempt based on the object corresponding to the authentication object; or denying or limiting the access attempt based on the object not corresponding to the authentication object.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1G. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for enhanced user authentication using authentication object detection during a liveness verification for determining access for a user account, the system comprising:
one or more memories; and
one or more processors, communicatively coupled to the one or more memories, configured to:
detect an enrollment event associated with the user account, the enrollment event being initiated by an authorized user of the user account;
obtain one or more enrollment images of an authentication object based on detecting the enrollment event;
classify, using a classification machine learning model, the authentication object as unique or non-unique based on the one or more enrollment images;
select an object authentication machine learning model for use during user authentication based on whether the authentication object is unique or non-unique,
wherein a first object authentication machine learning model is selected as the object authentication machine learning model based on the authentication object being unique, or
wherein a second object authentication machine learning model is selected as the object authentication machine learning model based on the authentication object being non-unique; and
configure the one or more processors to use the object authentication machine learning model for authenticating the user account during an authentication event.

2. The system of claim 1, wherein the one or more processors are configured to:
generate, using the classification machine learning model, one or more reference embeddings based on the one or more enrollment images; and
store, in the one or more memories, the one or more reference embeddings in association with the user account, the one or more reference embeddings being stored for use during the authentication event.

3. The system of claim 1, wherein the first object authentication machine learning model is a Siamese neural network, and
wherein the second object authentication machine learning model is an image recognition classification model.

4. The system of claim 1, wherein the classification machine learning model is a pre-trained binary classifier model.

5. The system of claim 1, wherein the one or more processors are configured to:
based on the authentication object being unique:
generate, using the first object authentication machine learning model, one or more reference embeddings based on the one or more enrollment images; and
store, in the one or more memories, the one or more reference embeddings in association with the user account, the one or more reference embeddings being stored for use during the authentication event, and
based on the authentication object being non-unique:
determine, using the second object authentication machine learning model, a reference object classification based on the one or more enrollment images; and
store, in the one or more memories, the reference object classification in association with the user account, the reference object classification being stored for use during the authentication event.

6. The system of claim 5, wherein the one or more processors are configured to:
based on the authentication object being non-unique:
generate, using the second object authentication machine learning model, one or more classification embeddings based on the one or more enrollment images; and
determine, using the second object authentication machine learning model, the reference object classification based on the one or more classification embeddings.

7. The system of claim 1, wherein the one or more processors are configured to:
analyze, using the classification machine learning model, the one or more enrollment images to determine a uniqueness score of the authentication object based on one or more uniqueness factors; and
classify the authentication object as unique based on the uniqueness score satisfying a uniqueness threshold; or
classify the authentication object as non-unique based on the uniqueness score not satisfying the uniqueness threshold.

8. The system of claim 1, wherein the one or more processors are configured to:
generate, using the classification machine learning model, an embedding based on the one or more enrollment images;
compare, using the classification machine learning model, the embedding with embeddings of common objects based on a distance metric to generate one or more comparison results; and
classify, using the classification machine learning model, the authentication object as unique or non-unique based on the comparison results.

9. The system of claim 1, wherein the one or more processors are configured to:
detect the authentication event, the authentication event being associated with an access attempt for the user account, and the access attempt being initiated by an access requester;
obtain a live image of an object associated with the authentication event based on detecting the authentication event;
analyze, using the object authentication machine learning model, the object within the live image to verify whether or not the object corresponds to the authentication object; and
authenticate the access attempt based on the object corresponding to the authentication object; or
deny or limit the access attempt based on the object not corresponding to the authentication object.

10. The system of claim 9, wherein the authentication event is a multi-factor authentication (MFA) event.

11. The system of claim 9, wherein the one or more processors are configured to:
based on the authentication object being unique:
generate, using the first object authentication machine learning model, one or more reference embeddings of the authentication object based on the one or more enrollment images;
store, in the one or more memories, the one or more reference embeddings in association with the user account, the one or more reference embeddings being stored for use during the authentication event;
generate, using the first object authentication machine learning model, an embedding of the object based on the live image;
compare, using the first object authentication machine learning model, the embedding with the one or more reference embeddings to generate one or more comparison results ; and
determine, using the first object authentication machine learning model, whether or not the object corresponds to the authentication object based on the one or more comparison results.

12. The system of claim 11, wherein the comparison results are distance measurements acquired based on a distance metric.

13. The system of claim 11, wherein the one or more processors are configured to:
based on the authentication object being non-unique:
determine, using the second object authentication machine learning model, a reference object classification of the authentication object based on the one or more enrollment images;
store, in the one or more memories, the reference object classification in association with the user account, the reference object classification being stored for use during the authentication event;
determine, using the second object authentication machine learning model, an object classification of the object based on the live image;
compare, using the second object authentication machine learning model, the object classification with the reference object classification to generate a comparison result; and
determine, using the second object authentication machine learning model, whether or not the object corresponds to the authentication object based on the comparison result.

14. The system of claim 9, wherein the one or more processors are configured to:
based on the authentication object being non-unique:
determine, using the second object authentication machine learning model, a reference object classification of the authentication object based on the one or more enrollment images;
store, in the one or more memories, the reference object classification in association with the user account, the reference object classification being stored for use during the authentication event;
determine, using the second object authentication machine learning model, an object classification of the object based on the live image;
compare, using the second object authentication machine learning model, the object classification with the reference object classification to generate a comparison result; and
determine, using the second object authentication machine learning model, whether or not the object corresponds to the authentication object based on the comparison result.

15. The system of claim 14, wherein the one or more processors are configured to:
based on the authentication object being non-unique:
generate, using the second object authentication machine learning model, one or more reference classification embeddings of the authentication object based on the one or more enrollment images;
determine, using the second object authentication machine learning model, the reference object classification based on the one or more reference classification embeddings;
generate, using the second object authentication machine learning model, a classification embedding of the object based on the live image; and
determine, using the second object authentication machine learning model, the object classification based on the classification embedding.

16. The system of claim 1, wherein the one or more processors are configured to:
classify, using the classification machine learning model, the authentication object as appropriate or inappropriate for being used for authentication based on the one or more enrollment images; and
accept the authentication object for being used for authentication based on the authentication object being appropriate; or
reject the authentication object for being used for authentication based on the authentication object being inappropriate.

17. A system for enhanced user authentication using authentication object detection during a liveness verification for determining access for a user account, the system comprising:
one or more memories; and
one or more processors, communicatively coupled to the one or more memories, configured to:
detect an enrollment event associated with the user account, the enrollment event being initiated by an authorized user of the user account;
obtain one or more enrollment images of an authentication object based on detecting the enrollment event;
classify, using a classification machine learning model, the authentication object as appropriate or inappropriate for being used for authentication based on the one or more enrollment images; and
accept the authentication object for being used for authentication based on the authentication object being appropriate; or
reject the authentication object for being used for authentication based on the authentication object being inappropriate.

18. A method for performing object-based authentication for determining access to a user account, comprising:
detecting an enrollment event associated with the user account, the enrollment event being initiated by an authorized user of the user account;
obtaining, based on detecting the enrollment event, one or more enrollment images of an authentication object;
classifying, using a classification machine learning model, the authentication object as unique or non-unique based on the one or more enrollment images;
selecting an object authentication machine learning model for use during user authentication based on whether the authentication object is unique or non-unique, including selecting a first object authentication machine learning model as the object authentication machine learning model based on the authentication object being unique, or selecting a second object authentication machine learning model as the object authentication machine learning model based on the authentication object being non-unique; and
configuring one or more processors to use the object authentication machine learning model for authenticating the user account during an authentication event.

19. The method of claim 18, further comprising:
based on the authentication object being unique:
generating, using the first object authentication machine learning model, one or more reference embeddings based on the one or more enrollment images; and
storing, in one or more memories, the one or more reference embeddings in association with the user account, the one or more reference embeddings being stored for use during the authentication event; or
based on the authentication object being non-unique:
determining, using the second object authentication machine learning model, a reference object classification based on the one or more enrollment images; and
storing, in the one or more memories, the reference object classification in association with the user account, the reference object classification being stored for use during the authentication event.

20. The method of claim 18, further comprising:
detecting the authentication event, the authentication event being associated with an access attempt for the user account, and the access attempt being initiated by an access requester;
obtaining a live image of an object associated with the authentication event based on detecting the authentication event;
analyzing, using the object authentication machine learning model, the object within the live image to verify whether or not the object corresponds to the authentication object; and
performing one of:
authenticating the access attempt based on the object corresponding to the authentication object; or
denying or limiting the access attempt based on the object not corresponding to the authentication object.
